(19) United States
(12) Patent Application Publication
(10) Pub. No.: US 2016/0092801 A1
(43) Pub. Date: Mar. 31, 2016

(54) USING COMPLEXITY PROBABILITY TO PLAN A PHYSICAL DATA CENTER RELOCATION

(71) Applicant: INTERNATIONAL BUSINESS MACHINES CORPORATION, Armonk, NY (US)

(72) Inventors: Dennis M. Carden, Beacon, NY (US); Russell G. Conner, Sacramento, CA (US); Anthony M. Hunt, Hopewell Junction, NY (US); Francis M. Keithline, Oxford, CT (US); Clea A. Zolotow, Golden, CO (US)

(21) Appl. No.: 14/501,926

(22) Filed: Sep. 30, 2014

(51) Int. Cl. G06Q 10/06

(52) U.S. Cl. CPC G06Q 10/0631

(57) ABSTRACT

A method and associated systems for using complexity probability to plan a physical datacenter relocation. One or more processors receive descriptions of each entity to be relocated, each of which is identified by a classification and by a tier that is associated with a level of complexity. Normalized random numbers are generated for each classification/tier combination and are each associated with a relocation scenario in which random complexity has a distinct amount of effect on the duration of time needed to relocate entities of the corresponding classification and tier. These numbers are then used to identify probable relocation times, each associated with one scenario, one classification, and one amount of complexity effect. These probable relocation times are then organized by classification so as to identify complexity-compensated probabilities that relocating all entities of a particular classification will require a specific duration of time.

### TECHNICAL FIELD

The present invention relates to relocating computerized data centers.

### BACKGROUND

Relocating a data center or other computing or business environment requires a method of accurately estimating how much time and how many resources will be necessary to move each subset of the data center's hardware and software entities.

Conventional linear methods may base such estimates on an assumption that, on average, a fixed number of entities may be moved each month. But these methods don't account for variable complexity factors like equipment age, equipment concurrency, telecommunications constraints, and security requirements. When a hard-to-predict complexity factor materially affects a move, the result may be a significant deviation from time and resource-consumption estimates.

### BRIEF SUMMARY

A first embodiment of the present invention provides a method for using complexity probability to plan a datacenter relocation project, the method comprising:

one or more processors of a computer system receiving a description of a set of entities to be relocated by the datacenter relocation project;

the one or more processors associating each entity of the set of entities with a category of a set of categories and a tier of a set of tiers;

the one or more processors further receiving historical data that identifies a previous duration of time required to perform previous relocation projects;

the one or more processors identifying an initial set of durations as a function of the historical data, wherein each initial duration of the initial set of durations estimates how long it will take to relocate all entities of the set of entities that are associated with a unique combination of a category of the set of categories and a tier of the set of tiers;

the one or more processors generating a multitude of random numbers;

the one or more processors estimating a set of complexity-compensated relocation durations, wherein a first complexity duration of the set of complexity-compensated relocation durations is estimated as a function of a first duration of the initial set of durations and a first random number of the multitude of random numbers, and identifies a distinct amount of time required to relocate all entities of the set of entities that are associated with a one category of the set of categories.

A second embodiment of the present invention provides a computer program product, comprising a computer-readable hardware storage device having a computer-readable program code stored therein, said program code configured to be executed by one or more processors of a computer system to implement a method for using complexity probability to plan a datacenter relocation project, the method comprising:

the one or more processors receiving a description of a set of entities to be relocated by the datacenter relocation project;

the one or more processors associating each entity of the set of entities with a category of a set of categories and a tier of a set of tiers;

the one or more processors further receiving historical data that identifies a previous duration of time required to perform previous relocation projects;

the one or more processors identifying an initial set of durations as a function of the historical data, wherein each initial duration of the initial set of durations estimates how long it will take to relocate all entities of the set of entities that are associated with a unique combination of a category of the set of categories and a tier of the set of tiers;

the one or more processors generating a multitude of random numbers;

the one or more processors estimating a set of complexity-compensated relocation durations, wherein a first complexity duration of the set of complexity-compensated relocation durations is estimated as a function of a first duration of the initial set of durations and a first random number of the multitude of random numbers, and identifies a distinct amount of time required to relocate all entities of the set of entities that are associated with a one category of the set of categories.

A third embodiment of the present invention provides a computer system comprising one or more processors, a memory coupled to the one or more processors, and a computer-readable hardware storage device coupled to the one or more processors, the storage device containing program code configured to be run by the one or more processors via the memory to implement a method for using complexity probability to plan a datacenter relocation project, the method comprising:

the one or more processors receiving a description of a set of entities to be relocated by the datacenter relocation project;

the one or more processors associating each entity of the set of entities with a category of a set of categories and a tier of a set of tiers;

the one or more processors further receiving historical data that identifies a previous duration of time required to perform previous relocation projects;

the one or more processors identifying an initial set of durations as a function of the historical data, wherein each initial duration of the initial set of durations estimates how long it will take to relocate all entities of the set of entities that are associated with a unique combination of a category of the set of categories and a tier of the set of tiers;

the one or more processors generating a multitude of random numbers;

the one or more processors estimating a set of complexity-compensated relocation durations, wherein a first complexity duration of the set of complexity-compensated relocation durations is estimated as a function of a first duration of the initial set of durations and a first random number of the multitude of random numbers, and identifies a distinct amount of time required to relocate all entities of the set of entities that are associated with a one category of the set of categories.

### BRIEF DESCRIPTION OF THE DRAWINGS

FIG. 1 shows the structure of a computer system and computer program code that may be used to implement a method for using complexity probability to plan a physical datacenter relocation in accordance with embodiments of the present invention.

FIG. 2 is a flow chart that illustrates a method for using complexity probability to plan a physical data center relocation in accordance with embodiments of the method of the present invention.

FIG. 3 is a flow chart that illustrates details of steps of FIG. 2, in accordance with embodiments of the present invention.

FIG. 4 shows a sample histogram generated as a function of duration values derived by a method of FIG. 3 in accordance with embodiments of the present invention.

### DETAILED DESCRIPTION

Relocating a data center, cloud-computing platform, or other computing or business environment requires a means of accurately estimating the time, labor, and resources necessary to complete the job.

In some cases, this task may be further complicated by distinctions among categories of entities to be moved that, wherein such a distinction places or removes a constraint upon a task of moving an entity in a particular class. An entity may, for example, be associated with a category based on one or more characteristics of the entity, its users, its platform, its mode of operation, its criticality, or other implementation-dependent characteristics.

A task of migrating a mission-critical transaction-processing application to a server farm at a remote site, for example, may require a significantly different set of resources or be associated with different time constraints than would a task of migrating a similar, but noncritical, application.

These categories may comprise any sort of organizational structure that satisfies a goal or other requirement associated with a project manager, entity owner, technology, financial consideration, or other implementation-dependent factor.

For illustrative purposes, examples provided herein will generally discuss embodiments that comprise an exemplary set of categories assigned to software and the hardware it runs on: noncritical, critical, lift-and-shift (“L&S”), virtual migration, and Application on Demand (AoD).

These examples should not be construed to limit embodiments of the invention to only those categories, to all of those categories, to computer- or communications-related entities, to cloud migrations or non-cloud migrations, or to computer data centers.

In these examples, a noncritical entity may be one that may be moved within a broad period of time or that is not subject to a dependency relationship that requires it to be moved before, after, or concurrently with an other entity. A critical entity may be one that must be moved within a specific time period, in a particular sequence, or that has a dependency relationship with another entity that requires it to be moved before, after, or concurrently with the other entity. An L&S entity is a physical device that must be physically transported and a virtual migration entity is one that may be migrated by means of a virtualized software tool. An AOD entity is a hosted software application or virtualized entity running in a data center and accessed by remote users through a network.

In some embodiments, each category of entities to be moved may be further organized into tiers. Such further organization may, for example, partition all critical entities to be moved based on one or more characteristics that may comprise, but are not limited to, complexity. Such tiered organization may help identify a relative amount of complexity-related randomness associated with estimating time and resources needed to relocate an entity.

In one example, a set of “critical” software applications to be moved may be divided into three tiers, where each entity is sorted into a tier as a function of whether the application comprises a database and as a further function of the size or complexity of the database.

Existing linear project-management methodologies may be used to estimate time and resource requirements of a migration project based on an assumption that, on average, a fixed number of entities may be moved each month. But these methods don't account for variable or unpredictable complexity factors that can greatly alter move requirements.

In one example, if a local-area network comprises very old components, estimating the time to move the network may be made more complex by a probability that an older component may fail during the move or may be incompatible with some other resource at the destination site. In such a case, there is a probability, related to the age of the components, that actual move time will significantly deviate from linearly produced estimates of move requirements due to an age-related complicating event.

Many types of complexity factors may disrupt or otherwise render a move estimate inaccurate. These complexity factors may be implementation-dependent, business-dependent, or entity-dependent and may be functions of factors that comprise, but are not limited to, combinations of: equipment age, software age, equipment concurrency, telecommunications constraints, business requirements, standards compliance, financial constraints, resource limitations, and security requirements.

In some embodiments, each category of entity to be moved may be partitioned into a set of tiers based on complexity factors of that particular class. In other embodiments each category of entity to be moved may be partitioned into a set of tiers based on complexity factors common to an entire migration project.

The effect of these complexity factors is to spawn a randomized complexity factor that must be accounted for in order to produce more accurate estimates of time & resources necessary for a move. Embodiments of the present invention address this issue by acknowledging the existence of such randomized complexity factors and by generating a statistically based simulation of a migration project. This methodology produces complexity-compensated projections that mitigate an uncertainty or other effect of a random or unpredictable factor, such as a degree of complexity of a relocated entity, on an estimate of a duration of time required to relocate the entity. In some embodiments, a similar methodology may produce complexity-compensated projections that mitigate such effects on estimates of a minimum, maximum, or mean duration of time required to perform the relocation.

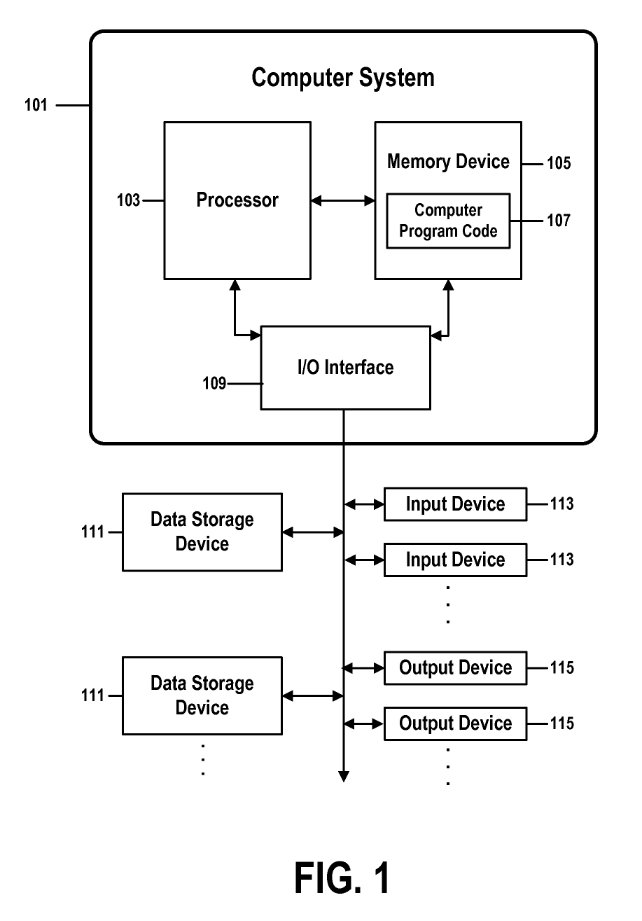

FIG. 1 shows a structure of a computer system and computer program code that may be used to implement a method for using complexity probability to plan a physical datacenter relocation in accordance with embodiments of the present invention. FIG. 1 refers to objects 101-115.

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In FIG. 1, computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method for using complexity probability to plan a physical datacenter relocation in accordance with embodiments of the present invention, and may implement other embodiments described in this specification, including the methods illustrated in FIGS. 1-4. The data storage devices 111 may store the computer program code 107. Computer program code 107 stored in the storage devices 111 is configured to be executed by processor 103 via the memory devices 105. Processor 103 executes the stored computer program code 107.

Thus the present invention discloses a process for supporting computer infrastructure, integrating, hosting, maintaining, and deploying computer-readable code into the computer system 101, wherein the code in combination with the computer system 101 is capable of performing a method for using complexity probability to plan a physical datacenter relocation.

Any of the components of the present invention could be created, integrated, hosted, maintained, deployed, managed, serviced, supported, etc. by a service provider who offers to facilitate a method for using complexity probability to plan a physical datacenter relocation. Thus the present invention discloses a process for deploying or integrating computing infrastructure, comprising integrating computer-readable code into the computer system 101, wherein the code in combination with the computer system 101 is capable of performing a method for using complexity probability to plan a physical datacenter relocation.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise said computer-readable hardware storage device.

While it is understood that program code 107 for using complexity probability to plan a physical data center relocation may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory.

Another alternative is to send program code 107 directly to a directory on the client computer hard drive. If proxy servers are configured, the process selects the proxy server code, determines on which computers to place the proxy servers' code, transmits the proxy server code, and then installs the proxy server code on the proxy computer. Program code 107 is then transmitted to the proxy server and stored on the proxy server.

In one embodiment, program code 107 for using complexity probability to plan a physical data center relocation is integrated into a client, server and network environment by providing for program code 107 to coexist with software applications (not shown), operating systems (not shown) and network operating systems software (not shown) and then installing program code 107 on the clients and servers in the environment where program code 107 will function.

The first step of the aforementioned integration of code included in program code 107 is to identify any software on the clients and servers, including the network operating system (not shown), where program code 107 will be deployed that are required by program code 107 or that work in conjunction with program code 107. This identified software includes the network operating system, where the network operating system comprises software that enhances a basic operating system by adding networking features. Next, the software applications and version numbers are identified and compared to a list of software applications and correct version numbers that have been tested to work with program code 107. A software application that is missing or that does not match a correct version number is upgraded to the correct version.

A program instruction that passes parameters from program code 107 to a software application is checked to ensure that the instruction's parameter list matches a parameter list required by the program code 107. Conversely, a parameter passed by the software application to program code 107 is checked to ensure that the parameter matches a parameter required by program code 107. The client and server operating systems, including the network operating systems, are identified and compared to a list of operating systems, version numbers, and network software programs that have been tested to work with program code 107. An operating system, version number, or network software program that does not match an entry of the list of tested operating systems and version numbers is upgraded to the listed level on the client computers and upgraded to the listed level on the server computers.

After ensuring that the software, where program code 107 is to be deployed, is at a correct version level that has been tested to work with program code 107, the integration is completed by installing program code 107 on the clients and servers.

Embodiments of the present invention may be implemented as a method performed by a processor of a computer system, as a computer program product, as a computer system, or as a processor-performed process or service for supporting computer infrastructure.

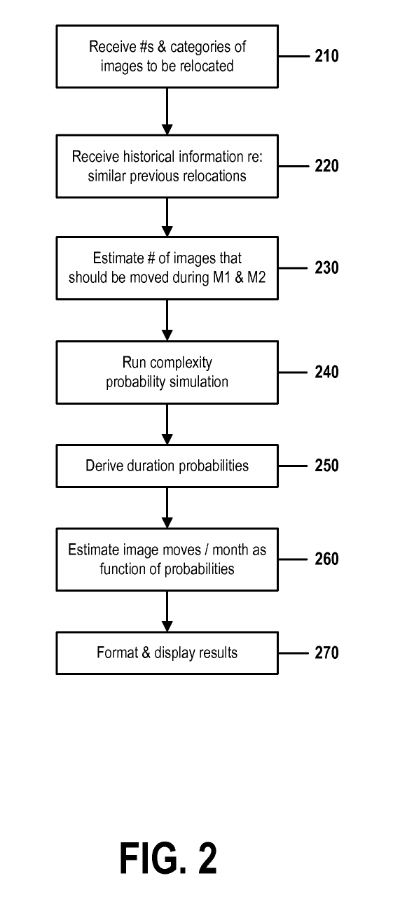

FIG. 2 is a flow chart that illustrates a method for using complexity probability to plan a physical data center relocation in accordance with embodiments of the method of the present invention. FIG. 2 shows steps 210-270.

In step 210, one or more processors receives information enumerating and describing the entities to be relocated as part of a relocation project. In examples described herein, these entities may comprise software images, virtual machines, application instances, physical computing and communications resources, and other entities being relocated from a first data center to one or more target data centers. In order to simplify the descriptions of FIG. 2, we will refer here to embodiments that comprise relocation projects intended to move “images” between “data centers.” This should not, however, be construed to limit embodiments of the present invention to such types of projects.

In some embodiments, for example, relocated entities may comprise a combination of any types of hardware or software, physical or virtual, or other types of entities. In some embodiments, the relocation project may move entities between a locations other than a computing data center, cloud-computing platform, or telecommunications installation.

The relocation project may, for example, comprise tasks of moving software images from a first cloud-computing environment to a second cloud-computing environment, or may comprise tasks of moving hardware components or network-infrastructure components from a first data center to a second data center. But in other cases, a relocation project may comprise tasks of moving one or more other types of entities, such as mechanical or electric equipment, inventories, employee workstations, paper or electronic records, fixtures, or any other type of movable entity, from a first physical or virtual location to a second physical or virtual location.

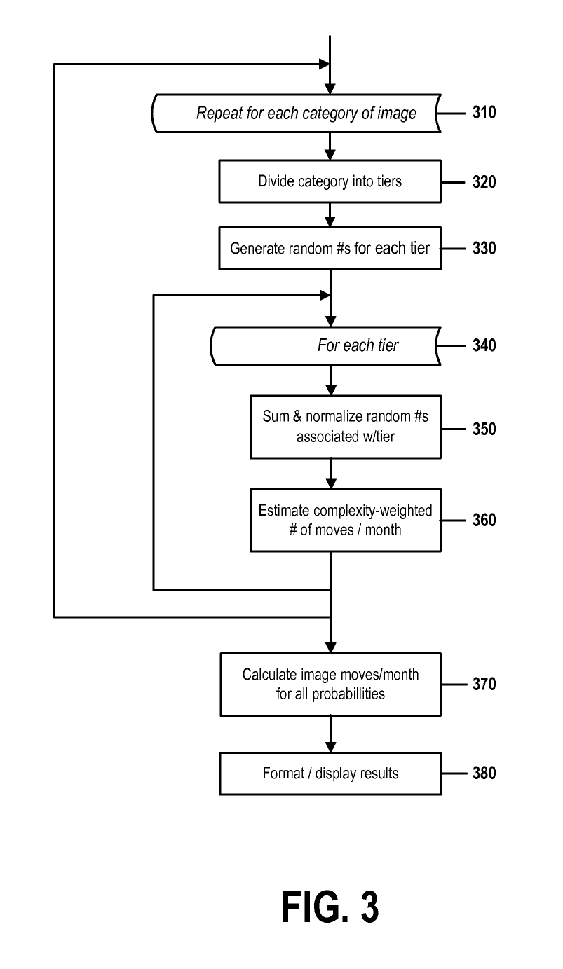

The descriptions received in this step associate each image to be moved with one classification of a set of categories and with one tier of a set of tiers. As described above, a classification of a first image may be identified as a function of a characteristic or use of that first image. In examples discussed in the descriptions of FIG. 2 and FIG. 3, each image will be associated with one of the five categories described above: noncritical, critical, lift-and-shift (“L&S”), virtual migration, and Application on Demand (AoD). In other embodiments, other categories may be used, as a function of implementation-dependent factors, as needed in order to organize the received images in a logical manner. In some embodiments, these categories will be selected such each classification is associated with a characteristic of an entity that affects an ability to accurately estimate a duration of time or an amount of a resource required to move the entity.

Each received description of an image will also identify a tier that is associated with a degree of complexity associated with a task of relocating the image. Such tiering may allow relocation-time estimates of images in a particular tier to be weighted as a function of their complexity. In such an organization, an image of a tier associated with greater complexity may be associated with a weighting such that estimates of a relocation time necessary to relocate that image identify longer relocation times.

Such tiering does not, however, account for an effect of complexity-related randomness associated with an estimated duration or time or amount of resources needed to relocate the image. Unknown or random complexity factors that may arise during a relocation may skew relocation-time estimates in an unpredictable manner that is not accounted for by assumptions of a fixed relationship between image complexity and relocation time.

At the conclusion of step 210, the one or more processors will thus have received information about each image (or other entity) to be relocated by the relocation project, where that information comprises an identification of a classification of each image and an identification of a tier associated with each image.

In a running example of this description of FIG. 2 and FIG. 3, this information allows the images to be organized into five categories as a functionality of the type, importance, and usage of each image, where the images of a particular category of the five categories are further organized into three tiers as a function of an estimated complexity of a task of relocating each image of the images of the particular class. As mentioned above, embodiments of the present invention may comprise more than or fewer than five categories or categories and more than or fewer than three tiers.

In examples described herein, each classification comprises images into three tiers: Tier One, Tier Two, and Tier Three, where Tier One comprises images associated with the least amount of relocation complexity and Tier Three comprises images associated with the greatest amount of relocation complexity. This classification scheme should not be construed to limit embodiments of the present invention to three tiers or to these three particular tiers.

In step 220, the one or more processors further received historical data about an amount of time or resources needed in the past to relocate images that may share characteristics with the images to be moved.

This historical data may comprise, but is not limited to: an average amount of time to move an image of a certain classification or tier from a first type of data center to a second type of data center; a standard deviation of such average amounts of time; or other information that may be used in estimating an amount of time or resources that may be required in order to move the images described by information received in step 210 as part of the relocation project.

If a project manager or other responsible party deems that an amount of available historical data is insufficient to provide statistically meaningful results, the manager or other party may instead select arbitrary values or select values as a function of the manager's or other party's expert knowledge of the entities to be moved, the source and target data centers, business or financial constraints, or other factors known to a person with expert knowledge or skilled in the art.

In step 230, the one or more processors estimate a number of images that should be moved during the first two months of the relocation project.

In some embodiments, the one or more processors in step 230 identify an average number of images of a particular category and tier that may be moved in a month as a function of information received or selected in step 220.

In one example, information received or selected in step 220 might indicate that, in 35 previous relocation projects that each share characteristics with the current relocation project, Tier Two AoD images were moved on average at a rate of 100 images/month. In this example, the one or more processors might estimate, as a function of this information, that 100 Tier Two AoD images may be moved during month one of the current relocation and that 100 Tier Two AoD images may be moved during month two of the current relocation. For purposes of this example, we refer to these two estimates as M1 (referring to Month 1) and M2 (referring to Month 2).

Although the examples herein generally comprise references to the AoD migration category, this convention is used solely to increase readability. should not be construed to limit the present invention to embodiments that comprise an AoD category.

In some embodiments, M1 and M2 may be derived as other functions of the information received or selected in step 220. If, for example, new migration tools promise to simplify AoD applications, values of M1 and M2 for Tier Two AoD images may be discounted to account for a decrease in relocation complexity.

If historic information was not available in step 220, a rough estimate of M1 and M2 may be identified here by a person with expert knowledge of characteristics of the business, the images, or other entities associated with the relocation project.

In step 240, the one or more processors perform a probability simulation that generates a set of relocation scenarios. Each simulated scenario may be associated with a distinct number of actual image-relocations per unit time for each tier of each classification of image. These distinct numbers of actual relocations may be identified as a function of random, pseudo-random, or statistically derived probabilities that one or more complexity factors will materially affect certain relocation tasks comprised by the relocation project.

In our running example, the one or more processors in this step may generate 1000 possible relocation scenarios for each of the fifteen classification/tier combinations. Each of these 15,000 scenarios identify one possible duration of time needed to move images associated with a particular tier and a particular classification.

Procedures of an embodiment of step 240 are described in greater detail in FIG. 3.

In step 250, the one or more processors analyze the scenarios generated in step 240 in order to generate a set of probabilities that each identify a probability that a particular duration of time will be needed to move one subset of the set of images to be relocated by the relocation project.

In some embodiments, each probability will be associated with a duration of time needed to relocate all images identified by a distinct combination of tier and classification. In some embodiments, each probability will be associated with a duration of time needed to relocate a subset of all images identified by a distinct combination of tier and classification. Such a subset might, for example, comprise a certain number of such images, where that certain number is selected as a function of the average number of images moved during a unit of time in previous relocation projects (identified by historical data received in step 220); or might comprise a certain number of such images, where that certain number is selected as a function of the estimated number of images that should be moved during a period of time (as identified in step 230).

Procedures of an embodiment of step 250 are described in greater detail in FIG. 3.

In step 260, the one or more processors determine, as a function of the probabilities generated in step 250, maximum, minimum, and mean durations of time to relocate all images, regardless of tier, of each classification. In some embodiments, the one or more processors in this step may identify other durations of interest by similar means or as similar functions of the probabilities generated in step 250. The one or more processors may, for example, in this step identify a range of durations that fall within two standard deviations of a mean value, a set of maximum, minimum, and mean durations required to relocate all images associated with a particular tier, or a set of maximum, minimum, and mean durations required to relocate all images associated with a particular tier/classification combination.

Procedures of an embodiment of step 260 are described in greater detail in FIG. 3.

In step 270, the one or more processors organize, format, or display the results produced by steps 210-260. In some embodiments, this may comprise creating one or more histograms or tables that may each be associated with a task of relocating images associated with a particular classification or with a particular combination of classification and tier. Each such representation may illustrate a set of probabilities, where each probability of the set of probabilities represents a probability that the task will require a certain duration of time.

There are many other ways to graphically, textually, or visually represent the probabilities, estimated durations, and other information identified here, and many of these types of graphs, charts, tables, histograms, and other representational techniques are known to those skilled in the art of data presentation. In some embodiments, for example, the one or more processors in step 270 may generate a set of bar graphs that show maximum, minimum, and mean estimates of durations of time needed to relocate all images identified by one or more categories or by one or more tiers.

FIG. 3 is a flow chart that illustrates steps 240-260 of FIG. 2 in greater detail, in accordance with embodiments of the present invention. FIG. 3 comprises steps 310-380.

In step 310, the one or more processors begin an outer iterative process of steps 310-360 that is performed once for each classification that may be associated with one or more of the images received in step 210.

In the running example of FIG. 2, which describes an embodiment that, for illustrative purposes, comprises five categories of images, the outer iterative process would be performed five times.

In step 320, the one or more processors organize into tiers the received images associated with the classification being analyzed (the “current classification”) in the current iteration of the outer iterative process of steps 310-360.

In some embodiments, as described above, an image might be sorted into a particular tier as a function of the image's complexity, or as a function of a complexity of a task of relocating the image. A Tier One, for example, might comprise images associated with a least degree of complexity, a Tier Two might comprise images associated with a relatively moderate degree of complexity and a Tier Three might comprise images associated with a greatest degree of complexity.

In the running example, which comprises three distinct tiers, the one or more processors in a first iteration of step 320 would sort into three such tiers all received images that are associated with the AoD classification.

In this example, the AOD classification is arbitrarily selected, for illustrative purposes, from the five categories as being the current classification associated with this first iteration of the outer iterative process of steps 310-360.

In step 330, the one or more processors generate a set of random numbers for each image associated with the current classification being processed by the outer iterative procedure of steps 310-360. These numbers may be generated by any means known to those skilled in the art.

In our running example, 200 images are associated with classification AoD and Tier One, 100 images are associated with classification AoD and Tier Two, and 100 images are associated with classification AoD and Tier Three. In this step in this example, the one or more processors generate 1000 distinct numbers for each of the 400 images associated with the current classification AoD.

In other examples or embodiments, a different number of random numbers may be generated for each image as a function of implementation-dependent factors. Some embodiments, for example, may generate a different number of random numbers for each tier. In some cases, a number of generated random numbers may be a function of other factors known to those skilled in the art or possessed of expert knowledge. The number of random numbers may, for example, be required to be greater than a minimum number of random numbers deemed by a project manager or other person to be adequate to produce statistically meaningful results, or may be required to be less than a maximum number of random numbers that may be reasonably processed by an embodiment or implementation of the method of the present invention. In some embodiments, a statistically valid minimum number of random numbers associated with each combination of category and tier may be set to a predefined value, such as 1000.

In this example, at the conclusion of step 330, the one or more processors will have generated 400,000 random numbers, 1000 for each of 400 images associated with the current AoD classification. 200,000 numbers will have been generated for the 200 AoD Tier One images, 100,000 numbers will have been generated for the 100 AoD Tier Two images, and 100,000 numbers will have been generated for the 100 AoD Tier Three images.

Each of the 1000 generated random numbers associated with an image associated with a particular classification and tier corresponds to an effect of a complexity factor, in one simulated scenario, on a relocation time of that image. Because a complexity factor may affect a relocation time of an image at random times or to a random degree of effect, these random numbers may thus each correspond to a degree of effect of a complexity factor on a particular image's relocation time in a particular scenario.

In step 340, the one or more processors begin an inner nested iterative process of steps 340-360 that is performed once for each tier of the current classification being processed by the outer iterative process of steps 310-360.

In the running example, one iteration of this inner iterative process is performed for the current AoD classification, for each of the three tiers of the example.

In step 350, each of the random numbers generated for the current tier/classification combination is normalized such that the random numbers fall within a specified range of values. Many types of appropriate normalization procedures are known to those skilled in the art. In some embodiments, a goal of a normalization procedure is to scale each generated random number to fall within an inclusive range spanning 0.00 through 1.00. In some embodiments, a goal of a normalization procedure is to scale each generated random number to fall within range greater than 0.00 and less than or equal to 1.00.

In our running example, a normalization procedure may generate a normalized random weighting for each set of all images associated with a particular classification and tier. Consider, in our running example, a case in which T1 is a sum of all 20,000 random numbers associated with Tier One AoD images, T2 is a sum of all 10,000 random numbers associated with Tier Two AoD images, and T3 is a sum of all 10,000 random numbers associated with Tier Three AoD images.

T1, T2, and T3 may then be normalized to respectively normalized values T1n, T2n, and T3 by the following procedure:

TTotal=T1+T2+T3

T1n=T1/TTotal

T2n=T2/TTotal

T3n=T3/TTotal

In other embodiments, other normalization procedures known to those skilled in the art may be used to generate normalized values that comply with requirements specific to a particular relocation project.

In step 360, the one or more processors estimate a number of moves per month that may be performed for each tier of images associated with the current classification.

The number of images that may be moved in the first or second month for a tier T and the current classification C may be expressed as a function of a normalized random value associated with that tier and classification, and as a further function of an average number of moves per month identified in step 230.

Initial phases of a relocation project may be associated with lower productivity, due to one-time setup tasks and initial learning curves that may be associated with early stages of the project, and that require additional resources or effort. Some embodiments of the present invention, therefore, may estimate different a number of images that may be moved during early months of the project that is distinct from a number of images that may be moved in subsequent months. In the running examples described herein, we illustrate this feature by identifying an estimated number of images that may be moved during each of the first two months of a relocation project to be 50% of a number of images that may be moved in subsequent months

In our running example, consider a case in which the one or more processors in step 230 estimated that, based on a linear projection of historical information about past relocation projects, a linear estimation process would determine that M1 images

These figures might be derived by the following equations, in which Tx_Ci is a compensated number of {Tier x classification C} images that may be moved during either month 1 or month 2 of the relocation project, and where the ceil function rounds up a value of its argument to the next highest positive integer.

For example, T1_AoDi estimates a number of images associated with Tier One and classification AoD that may be relocated during either month one or month two of the relocation project as:

T1_AoDi=ceil((T1n*AoD)−(AoD_Move_T1))

Here, T1n is the normalized random factor associated with AoD Tier One images, AoD is the total number of images (regardless of tier) associated with classification AoD, and AoD_Move_T1 is the step 230 estimate of the average number of AoD Tier One images that may be moved per month, based on historical data.

Similar figures for AoD Tier Two and AoD Tier Three images may be identified by analogous computations:

T2_AoDi=ceil((T2n*AoD)−(AoD_Move_T2))

T3_AoDi=ceil((T3n*AoD)−(AoD_Move_T3))

In one example, consider a case in which:
i) a normalized random value associated with AoD Tier One images was determined in step 350 to have a value of 0.386;
ii) 100 AoD images, from all tiers, must be moved; and
iii) the computations of step 230 determined that, based on historical data, one can expect to be able to move on average 20 AoD Tier One images/month.

A compensated number of moves T1_AoDi of AoD Tier One images during each of the first two months may then be determined by the formula:

T1_AoDi=ceil((0.388*100)−(20))=

T1_AoDi=ceil(38.8−20)=

T1_AoDi=ceil(18.8)=

T1_AoDi=19 moves per month(Month One & Month Two)

The one or more processors then identifies for each tier a value Tx_C (a duration of time, not including Month One and Month Two, to move all images associated with classification C and Tier x) as a number of images to be moved after the first two months divided by the number of images may be moved per month.

For example, T1_AoD may be derived by dividing T1_AoDi, the previously computed compensated number of moves of AoD Tier 1 images expected during each of the first two months; by AoD_Move_T1, the step 230 estimate of the average number of AoD Tier One images that may be moved per month, based on historical data. In other words, T1_AoD estimates a number of months needed to move AoD Tier One images after the first two months of the relocation project:

T1_AoD=T1_AoDi/(AoD_Move_T1+1)

In this equation, a value of 1 is added to the denominator in order to prevent singularities that may arise if AoD_Move_T1 has a zero or null value.

In the current example, this formula could be evaluated thus:

T1_AoD=T1_AoDi/(AoD_Move_T1+1)=

T1_AoD=19/(20+1)=

T1_AoD=0.9 months

Analogous values for AoD Tier Two images and AoD Tier Three images may be derived by similar calculations:

T2_AoD=T2_AoDi/AoD_Move_T2+1;

T3_AoD=T3_AoDi/AoD_Move_T3+1;

At this point, the one or more processors will have identified a number of images associated with the current classification, and broken out by tier, that may be moved in each of the first two months of the relocation project, and will have further identified a duration of time needed to move all remaining images associated with the current classification, broken out by tier. These figures are all adjusted by the inclusion of the normalized random complexity factors generated in step 350 in order to more accurately predict relocation times that may be randomly altered by levels of complexity associated with each tier.

If one or more tiers of the current classification have not yet been considered by the inner iterative process of steps 340-360, then the inner iterative process repeats for the next tier of the current classification. If all tiers of the current classification have been considered, then the last iteration of the inner iterative process of steps 340-360 concludes and the method of FIG. 3 continues with the next iteration of the outer iterative process of steps 310-360. This next iteration will consider the next classification.

If all categories have been considered by iterations of the outer iterative process of steps 310-360, then this outer iterative process ends and the method of FIG. 3 concludes with step 370.

In step 370, the one or more processors derive the longest complexity-compensated durations of time required to move all images, regardless of tier, that are associated with each classification. These derivations are performed by means of equations of the form:

MD(C)=ΣTx_C

where C is a classification, MD(C) is a maximum duration of time to move all images associated with classification C, Tx_C is a time, not including Month One and Month Two, to move all images associated with classification C and Tier x, and ΣTx_C is thus the total duration of time, not including Month One and Month Two, required to move all images of all tiers that are associated with classification C.

For example, if images may be associated with any of three tiers, a maximum amount of time, not including Month One and Month Two, required to move all images associated with classification AoD would be determined as:

MD(AoD)=T1_AoD+T2_AoD+T3_AoD+2

Note that this slightly variant equation adds an additional two months to the longest-possible duration in order to include Month One and Month Two in the duration estimate. The resulting MD(AoD) figure estimates a duration of time necessary to move all AoD images of all tiers in a worst-case scenario, when it is not possible to move images of different tiers concurrently.

In this example, in which T1_AoD is a complexity-adjusted duration of time necessary to move all AoD Tier One images (starting with Month Three of the relocation project), T2_AoD is a complexity-adjusted duration of time necessary to move all AoD Tier Two images (starting with Month Three of the relocation project), and T3_AoD is a complexity-adjusted duration of time necessary to move all AoD Tier Three images (starting with Month Three of the relocation project), and if these three figures are, respectively, 0.9 months, 1.6 months, and 2.0 months, the longest possible duration of time necessary to relocate all three tiers of AOD images may be identified as:

MD(AoD)=T1_AoD+T2_AoD+T3_AoD+2=

MD(AoD)=0.9+1.6+2.0+2=

MD(AoD)=4.5+2=

MD(AoD)=6.5 months.

Because large numbers of randomized, normalized complexity-factor values were generated in steps 330 and 350, there are multiple values of each Tx_C parameter. If, for example, 1000 random numbers were generated in step 330 for each tier of the current classification, then step 350 will have generated 1000 normalized complexity-factor values associated with AoD Tier One images, 1000 normalized complexity-factor values associated with AoD Tier Two images, and 1000 normalized complexity-factor values associated with AoD Tier Three images.

Each of these 1000 normalized complexity-factor values is associated with a distinct relocation scenario in which the complexity factor has a particular effect on a duration of time needed to move images associated with a particular classification and tier. Consequently, each of 1000 move durations T1_AoD identified in step 360 is associated with one of these 1000 scenarios and has been weighted accordingly to account for a statistical likelihood of an effect of a complexity factor upon the duration.

The one or more processors in step 370 thus, in our running example, would derive 1000 values of MD(AoD), each of which identifies a maximum duration of time to move all AoD images, regardless of tier, in one particular scenario. Similarly, 1000 similar maximum duration values would have been derived in step 370 for each of the other four categories. The one or more processors, in this example, will have produced 5000 maximum-duration estimates, each of which is weighted by a random complexity value.

In other embodiments, a number of random normalized values other than 1000 may be derived, but in all cases, the number of random values must be great enough to be deemed statistically significant by a project manager or other person skilled in the art.

In step 380, the one or more processors analyze and format the duration figures MD( ) derived in step 370. This analysis may be performed by means of statistical methods known to those in the art or by an other method specific to an embodiment of the present invention.

Tier-specific move durations Tx_C that are summed to produce a particular value maximum duration MD may be selected by any method acceptable to the relocation project manager or to other persons skilled in the art.

In a simple implementation, the values may be grouped in order of generation. If, for example, 1000 AoD Tier One values T1_AoD(1 . . . 1000), 1000 AoD Tier Two values T2_AoD(1 . . . 1000), and 1000 AoD Tier Three values T1_AoD(1 . . . 1000) are generated in step 370, 1000 AOD duration figures MD(AoD(1 . . . 1000)) may be computed by calculations of the form:

MD(AoD,1)=T1_AoD(1)+T2_AoD(1)+T3_AoD(1)+2

MD(AoD,2)=T1_AoD(2)+T2_AoD(2)+T3_AoD(2)+2

MD(AoD,3)=T1_AoD(3)+T2_AoD(3)+T3_AoD(3)+2
and so forth.

In this example, a first generated value of MD(AoD) is derived as a sum of a first generated value of T1_AoD, a first generated value of T2_AoD, and a first generated value of T3_AoD; a second generated value of MD(AoD) is derived as a sum of a second generated value of T1_AoD, a second generated value of T2_AoD, and a second generated value of T3_AoD; and so forth.

But many other patterns or methods of grouping or selecting Tx_C figures in order to derive MD(C) durations are possible, so long as a specific Tx_C figure is not overweighted by being used more than once, and so long as a specific Tx_C figure is not underweighted by omitting it from any derivation of a value of MD(C).

In one example of a statistical method specific to an embodiment, the duration figures derived in step 370 may be used to generate a set of histograms, each of which displays probabilities that a task of relocating all images associated with a particular classification may be completed within a particular duration of time.

The analyzed and formatted duration figures may be displayed or published in this or in any other form known to those skilled in the art of information technology, statistics, project management, or related fields.

In some embodiments, these figures may be displayed as a bar chart or other type of graphical chart, as a table, or as a statistical function. Subsets of the figures may also be presented as a means of identifying or associating a subset with a particular requirement or other implementation-dependent condition. In one example, if project requirements demand that all AoD images be relocate within six months, a graphical representation of the results of step 370 may identify probabilities associated only with scenarios that specify complexity-compensated estimates of move durations less than or equal to six months.

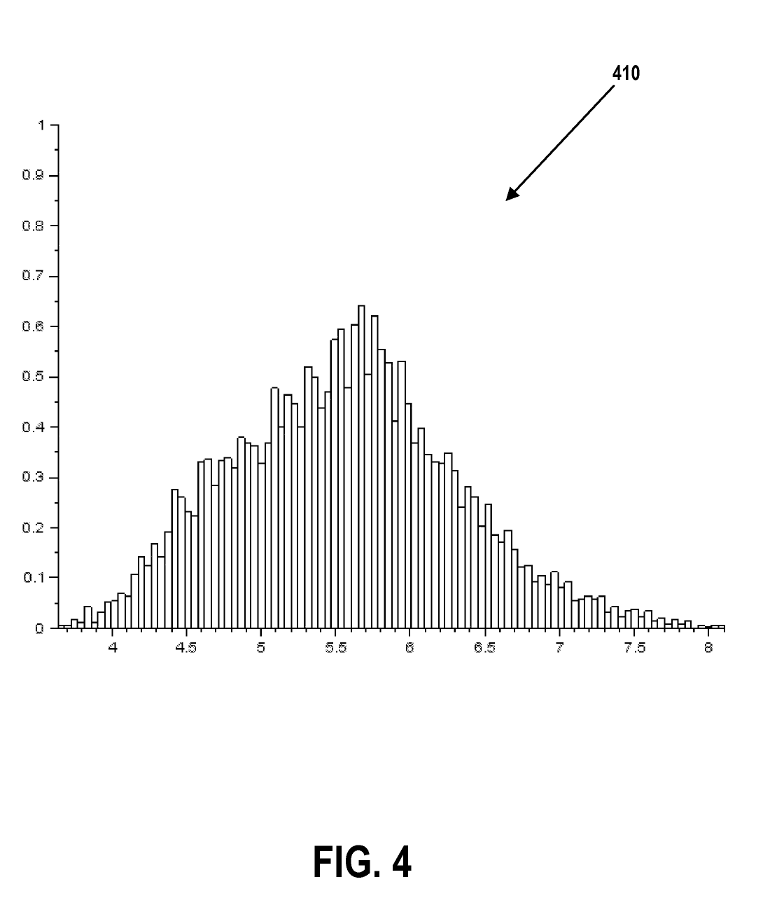

FIG. 4 shows a sample histogram generated as a function of duration values derived in step 380.

Item 410 is a histogram that graphically represents a statistical distribution of probabilities that relocating all AoD images will require certain durations of time. Here, the vertical axis of the histogram represents probabilities and the horizontal axis represents time. In this example, the horizontal axis is represented in units of months.

In the running example of FIG. 2 and FIG. 3, 1000 maximum-duration figures MD(AoD,1 . . . 1000) derived in step 380 are represented in histogram 410. If, for example, 57% of the 1000 MD(AoD) figures fall below 5.5 months, then the vertical bar at time 5.5 has a vertical amplitude of 0.57. This indicates that, given the randomized effects of complexity factors on the duration of time necessary to move all AoD images, there is a 57% chance that this duration will not exceed 5.5 months.

As discussed above in the description of step 380, many other representational methods are possible. In one case, a similar histogram may be generated that represents probabilities that a maximum-duration figure may be exactly equal to (not less than or equal to) a particular duration of time. In such a case, the 0.57 height of the bar of histogram 410 at 5.5 months would indicate a 57% probability that the duration of time necessary to move all AoD images will approximately equal 5.5 months.

Embodiments of the present method may thus comprise any type of analysis or method of representation deemed relevant to the goals of the relocation project by a project manager or other skilled person. In some embodiments, such an analysis or method may be selected as a function of project goals, such as identifying a “sweet spot” minimum duration that is most likely to be achieved without incurring unnecessary costs associated with an excessive duration.

What is claimed is:

1. A method for using complexity probability to plan a datacenter relocation project, the method comprising:
one or more processors of a computer system receiving a description of a set of entities to be relocated by the datacenter relocation project;
the one or more processors associating each entity of the set of entities with a category of a set of categories and a tier of a set of tiers;
the one or more processors further receiving historical data that identifies a previous duration of time required to perform previous relocation projects;
the one or more processors identifying an initial set of durations as a function of the historical data, wherein each initial duration of the initial set of durations estimates how long it will take to relocate all entities of the set of entities that are associated with a unique combination of a category of the set of categories and a tier of the set of tiers;
the one or more processors generating a multitude of random numbers;
the one or more processors estimating a set of complexity-compensated relocation durations, wherein a first complexity duration of the set of complexity-compensated relocation durations is estimated as a function of a first duration of the initial set of durations and a first random number of the multitude of random numbers, and identifies a distinct amount of time required to relocate all entities of the set of entities that are associated with a one category of the set of categories.

2. The method of claim 1, further comprising:
the one or more processors identifying a probability that a relocation of a subset of entities of the set of entities that is associated with the one category will require a probable duration of time, wherein the identifying is performed as a function of the set of complexity-compensated relocation durations.

3. The method of claim 1, wherein a tier of the set of tiers identifies a degree of complexity of the entity.

4. The method of claim 1, wherein a tier of the set of tiers identifies a degree of complexity of a task of relocating the entity.

5. The method of claim 1, wherein the category is selected from a group comprising: a critical entity, a noncritical entity, a virtualized image, a physical entity, and an application-on-demand software application.

6. The method of claim 1, wherein the random numbers are normalized prior to the estimating to a value no less than 0 and no greater than 1.

7. The method of claim 1, wherein the identifying further comprises generating a histogram that represents a probability that a particular duration of time will be necessary to relocate all entities of the set of entities that are associated with a particular category of the set of categories.

8. The method of claim 1, wherein the estimating the first complexity duration is performed as a further function of a sum of a set of compensated category/tier durations, and wherein each category/tier duration of the set of compensated category/tier durations identifies an estimated duration of time required to move all entities associated with the one category and with a selected tier of the set of tiers, and wherein the further function comprises weighting each category/tier duration of the set of compensated category/tier durations by an associated random number of the multitude of random numbers.

9. The method of claim 1, further comprising providing at least one support service for at least one of creating, integrating, hosting, maintaining, and deploying computer-readable program code in the computer system, wherein the computer-readable program code in combination with the computer system is configured to implement the receiving, associating, further receiving, identifying, generating, and estimating.

10. A computer program product, comprising a computer-readable hardware storage device having a computer-readable program code stored therein, said program code configured to be executed by one or more processors of a computer system to implement a method for using complexity probability to plan a datacenter relocation project, the method comprising:
the one or more processors receiving a description of a set of entities to be relocated by the datacenter relocation project;
the one or more processors associating each entity of the set of entities with a category of a set of categories and a tier of a set of tiers;
the one or more processors further receiving historical data that identifies a previous duration of time required to perform previous relocation projects;
the one or more processors identifying an initial set of durations as a function of the historical data, wherein each initial duration of the initial set of durations estimates how long it will take to relocate all entities of the set of entities that are associated with a unique combination of a category of the set of categories and a tier of the set of tiers;
the one or more processors generating a multitude of random numbers;
the one or more processors estimating a set of complexity-compensated relocation durations, wherein a first complexity duration of the set of complexity-compensated relocation durations is estimated as a function of a first duration of the initial set of durations and a first random number of the multitude of random numbers, and identifies a distinct amount of time required to relocate all entities of the set of entities that are associated with a one category of the set of categories.

11. The computer program product of claim 11, further comprising:
the one or more processors identifying a probability that a relocation of a subset of entities of the set of entities that is associated with the one category will require a probable duration of time, wherein the identifying is performed as a function of the set of complexity-compensated relocation durations.

12. The computer program product of claim 11, wherein a tier of the set of tiers identifies a degree of complexity of the entity.

13. The computer program product of claim 11, wherein the random numbers are normalized prior to the estimating to a value no less than 0 and no greater than 1.

14. The computer program product of claim 11, wherein the identifying further comprises generating a histogram that represents a probability that a particular duration of time will be necessary to relocate all entities of the set of entities that are associated with a particular category of the set of categories.

15. The computer program product of claim 11, wherein the estimating the first complexity duration is performed as a further function of a sum of a set of compensated category/tier durations, and wherein each category/tier duration of the set of compensated category/tier durations identifies an estimated duration of time required to move all entities associated with the one category and with a selected tier of the set of tiers, and wherein the further function comprises weighting each category/tier duration of the set of compensated category/tier durations by an associated random number of the multitude of random numbers.

16. A computer system comprising one or more processors, a memory coupled to the one or more processors, and a computer-readable hardware storage device coupled to the one or more processors, the storage device containing program code configured to be run by the one or more processors via the memory to implement a method for using complexity probability to plan a datacenter relocation project, the method comprising:
the one or more processors receiving a description of a set of entities to be relocated by the datacenter relocation project;
the one or more processors associating each entity of the set of entities with a category of a set of categories and a tier of a set of tiers;
the one or more processors further receiving historical data that identifies a previous duration of time required to perform previous relocation projects;
the one or more processors identifying an initial set of durations as a function of the historical data, wherein each initial duration of the initial set of durations estimates how long it will take to relocate all entities of the set of entities that are associated with a unique combination of a category of the set of categories and a tier of the set of tiers;
the one or more processors generating a multitude of random numbers;
the one or more processors estimating a set of complexity-compensated relocation durations, wherein a first complexity duration of the set of complexity-compensated relocation durations is estimated as a function of a first duration of the initial set of durations and a first random number of the multitude of random numbers, and identifies a distinct amount of time required to relocate all entities of the set of entities that are associated with a one category of the set of categories.

17. The computer system of claim 16, further comprising:
the one or more processors identifying a probability that a relocation of a subset of entities of the set of entities that is associated with the one category will require a probable duration of time, wherein the identifying is performed as a function of the set of complexity-compensated relocation durations.

18. The computer system of claim 16, wherein a tier of the set of tiers identifies a degree of complexity of the entity.

19. The computer system of claim 16, wherein the random numbers are normalized prior to the estimating to a value no less than 0 and no greater than 1.

20. The computer system of claim 16, wherein the identifying further comprises generating a histogram that represents a probability that a particular duration of time will be necessary to relocate all entities of the set of entities that are associated with a particular category of the set of categories.
